(19) United States
(12) Patent Application Publication
(10) Pub. No.: US 2024/0079655 A1
(43) Pub. Date: Mar. 7, 2024

(54) TAB-FREE BIPOLAR SOLID-STATE BATTERY

(71) Applicant: GM GLOBAL TECHNOLOGY OPERATIONS LLC, DETROIT, MI (US)

(72) Inventors: Qili SU, Shanghai (CN); Zhe LI, Anda (CN); Meiyuan WU, Shanghai (CN); Haijing LIU, Shanghai (CN); Dave G. RICH, Sterling Heights, MI (US)

(21) Appl. No.: 17/961,804

(22) Filed: Oct. 7, 2022

(30) Foreign Application Priority Data
Sep. 2, 2022 (CN) 202211070259.4

(51) Int. Cl. H01M 10/0585; H01M 4/66; H01M 10/0562; H01M 10/0565; H01M 10/0566; H01M 50/148; H01M 50/172; H01M 50/186; H01M 50/193; H01M 50/30; H01M 50/417; H01M 50/431; H01M 50/449; H01M 50/533; H01M 50/534; H01M 50/548

(52) U.S. Cl. CPC H01M 10/0585; H01M 4/661; H01M 10/0562; H01M 10/0565; H01M 10/0566; H01M 50/148; H01M 50/172; H01M 50/186; H01M 50/193; H01M 50/30; H01M 50/417; H01M 50/431; H01M 50/449; H01M 50/533; H01M 50/534; H01M 50/548; H01M 2300/0025; H01M 2300/0071; H01M 2300/0082

(57) ABSTRACT

A bipolar solid-state battery includes N solid-state battery cells. Each of the N solid-state battery cells includes M solid-state cores each comprising a first current collector, cathode active material, a separator, anode active material, and a second current collector, where N and M are integers greater than one. The M solid-state cores are connected in parallel by connecting the first current collectors of the M solid-state cores in each of the N solid-state battery cells together and by connecting the second current collectors of the M solid-state cores in each of the N solid-state battery cells together. N−1 clad plates including a first side made of a first material and a second side made of a second material. The N−1 clad plates are arranged between adjacent ones of the N solid-state battery cells and the N solid-state battery cells are connected in series by the N−1 clad plates.

### CROSS-REFERENCE TO RELATED APPLICATIONS

This application claims the benefit of Chinese Patent Application No. 202211070259.4, filed on Sep. 2, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery systems for vehicles, and more particularly to a tab-free solid-state battery and a battery enclosure.

Low voltage automotive battery systems such as 12V battery systems can be used for starting vehicles, supporting stop/start functionality, and/or supplying vehicle accessory loads or other vehicle systems. Low voltage automotive battery systems can also be used to support vehicle accessory loads in electric vehicles (EVs) such as battery electric vehicles, hybrid vehicles and/or fuel cell vehicles.

During cold starting or stop/start events, the battery system supplies current to a starter to crank the engine. When the vehicle is cold started, the battery needs to supply sufficient cranking power. In some applications, the battery system may continue to supply power for various electrical systems of the vehicle after the engine is started. An alternator or regeneration recharges the battery system.

### SUMMARY

A bipolar solid-state battery includes N solid-state battery cells, where N is an integer greater than one. Each of the N solid-state battery cells includes M solid-state cores each comprising a first current collector, cathode active material, a separator, anode active material, and a second current collector, where M is an integer greater than one. The M solid-state cores are connected in parallel by connecting the first current collectors of the M solid-state cores in each of the N solid-state battery cells together and by connecting the second current collectors of the M solid-state cores in each of the N solid-state battery cells together. N−1 clad plates including a first side made of a first material and a second side made of a second material. The N−1 clad plates are arranged between adjacent ones of the N solid-state battery cells and the N solid-state battery cells are connected in series by the N−1 clad plates.

In other features, the first current collector comprises aluminum and the second current collector comprises copper. The first material of the N−1 clad plates comprises copper and the second material of the N−1 clad plates comprises aluminum. The N solid-state battery cells and the N−1 clad plates are arranged in the battery enclosure.

In other features, a first terminal in contact with the first current collector of a first one of the N solid-state battery cells and passing through one side of the battery enclosure. A second terminal is in contact with the second current collector of a last one of the N solid-state battery cells and passes through an opposite side of the battery enclosure.

In other features, the bipolar solid-state battery includes an electrolyte. The electrolyte comprises polymer electrolyte and an initiator. A battery enclosure encloses the N solid-state battery cells. The polymer electrolyte is polymerized insitu in the battery enclosure.

In other features, the polymer electrolyte is selected from a group consisting of ethylene oxide (EO), vinylidene fluoride (VDF), vinylidene fluoride-hexafluoropropylene (VDF-HFP), propylene oxide (PO), acrylonitrile (AN), methacrylonitrile (PMAN), methyl methacrylate (MMA), and their corresponding oligomers and co-polymers. The initiator is selected from a group consisting of peroxide, azo compounds, and peroxide and a reducing agent. The battery enclosure includes a base portion and a cover. The cover includes N vent holes arranged between the N−1 clad plates, between a first one of the N−1 clad plates and one side of the battery enclosure, and between a last one of the N−1 clad plates and an opposite side of the battery enclosure. N fasteners are arranged in the N vent holes.

In other features, sealing polymer seals the N fasteners in the N vent holes. The electrolyte comprises liquid electrolyte. The liquid electrolyte is selected from a group consisting of a solvated ionic liquid and an aprotic ionic liquid.

In other features, the cathode active material includes one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

In other features, the anode active material is selected from a group consisting of a carbonaceous material, silicon, a transition metal, a metal oxide, a lithium metal, a lithium alloy metal, and combinations thereof. The separator comprises a polymer layer that is coated with lithium aluminum titanium phosphate (LATP) and wherein the polymer layer is selected from a group consisting of polypropylene (PP) and polyethylene (PE).

In other features, the electrolyte comprises an oxide-based solid electrolyte selected from a group consisting of doped or undoped garnet electrolyte, perovskite electrolyte, NASICON electrolyte, LISICON electrolyte, metal-doped oxide solid electrolyte, and aliovalent-substituted oxide solid electrolyte.

A battery enclosure includes a lower portion including a bottom surface, first and second side walls, first and second end walls and an opening, wherein the lower portion has a generally rectangular cross section. A cover is configured to enclose the opening of the lower portion. The battery enclosure includes N clad plates, where N is an integer greater than one. The first and second side walls and an inner surface of the cover include N channels configured to receive edges of the N clad plates, respectively. A first terminal is arranged in the first end wall. A second terminal is arranged in the second end wall.

In other features, the N channels hold the N clad plates in a spaced arrangement between the first and second end walls. The N clad plates are arranged in parallel between the first and second end walls. The first terminal and the second terminal further comprise an annular body defining an inner cavity including a first threaded portion and a first flange extending radially outwardly therefrom, and a terminal cap including a cylindrical body including a second threaded portion and a second flange extending radially outwardly from one end of the cylindrical body, wherein the first threaded portion is configured to threadably engage the second threaded portion.

In other features, the first flange has an outer diameter that is larger than a diameter of an opening in at least one of the first end wall and the second end wall. The second flange has a diameter that is larger than a diameter of the inner cavity of the annular body. The first terminal and the second terminal further comprise a cylindrical body including a flange extending radially outwardly therefrom. The first flange has a diameter that is larger than a diameter of an opening in at least one of the first end wall and the second end wall.

In other features, a first one of the first terminal and the second terminal corresponds to a positive terminal and is made of a material selected from a group consisting of stainless steel, aluminum, nickel, iron, titanium, tin, and alloys thereof. A second one of the first terminal and the second terminal corresponds to a negative terminal and is made of a material selected from a group consisting of stainless steel, copper, nickel, iron, titanium, tin, and alloys thereof.

In other features, the lower portion and the cover are injection molded around the first terminal and the second terminal. The cover includes N+1 vent holes passing through the cover. N+1 fasteners arranged in the N+1 vent holes. Sealing polymer provides a seal around the N+1 fasteners in the N+1 vent holes, respectively.

In other features, the cover includes a first stair-stepped surface. Edges of the first and second side walls and the first and second end walls define a second stair-stepped surface in the opening. The first stair-stepped surface is configured to mate with the second stair-stepped surface. The N clad plates include a first layer comprising copper and a second layer comprising aluminum.

In other features, the battery enclosure is made of a material selected from a group consisting of polyvinyl chloride (PVC), polyvinylidene fluoride (PVDF), polytetrafluoethylene (PTFE), chlorinated polyvinyl chloride (CPVC), chlorinated polyethylene (CPE), polypropylene (PP), polyethylene (PE), polybutylene (PB), and combinations thereof.

A tab-free battery comprising the battery enclosure and N+1 battery cells arranged between the first terminal and a first one of the N clad plates, between adjacent ones of the N clad plates, and between a last one of the N clad plates and the second terminal.

In other features, the N+1 battery cells comprise solid state battery cells. Each of the N+1 battery cells comprise M solid-state cores each comprising a first current collector, cathode active material, a separator, anode active material, and a second current collector, where M is an integer greater than one. The M solid-state cores are connected in parallel by connecting the first current collectors of the M solid-state cores in each of the N+1 battery cells together and by connecting the second current collectors of the M solid-state cores in each of the N+1 battery cells together. The N+1 battery cells are connected in series by the N clad plates.

In other features, polymer electrolyte is arranged in the battery enclosure. The polymer electrolyte is selected from a group consisting of ethylene oxide (EO), vinylidene fluoride (VDF), vinylidene fluoride-hexafluoropropylene (VDF-HFP), propylene oxide (PO), acrylonitrile (AN), methacrylonitrile (PMAN), methyl methacrylate (MMA), and their corresponding oligomers and co-polymers.

In other features, the polymer electrolyte is polymerized insitu in the battery enclosure.

In other features, liquid electrolyte is arranged in the battery enclosure. The liquid electrolyte is selected from a group consisting of a solvated ionic liquid and an aprotic ionic liquid.

In other features, the cathode active material includes one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In some examples, the anode active material is selected from a group consisting of a carbonaceous material, silicon, a transition metal, a metal oxide, a lithium metal, a lithium alloy metal and combinations thereof.

In other features, the anode active material is selected from a group consisting of a carbonaceous material, silicon, a transition metal, a metal oxide, a lithium metal, a lithium alloy metal (e.g., tin, aluminum, indium, magnesium) and combinations thereof. The separator comprises a polymer layer that is coated with lithium aluminum titanium phosphate (LATP) and wherein the polymer layer is selected from a group consisting of polypropylene (PP) and polyethylene (PE).

In other features, an electrolyte is arranged in the battery enclosure and is selected from a group consisting of doped garnet electrolyte, undoped garnet electrolyte, perovskite electrolyte, NASICON electrolyte, LISICON electrolyte, metal-doped oxide solid electrolyte, and aliovalent-substituted oxide solid electrolyte.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of a bipolar battery;

FIG. 2 is a side cross-sectional view of an example of a bipolar solid-state battery according to the present disclosure;

FIG. 3 is a side cross-sectional view of an example of a bipolar solid-state battery cell and a battery enclosure according to the present disclosure;

FIGS. 4A to 4D are top and bottom perspective views of an example of a bipolar battery cell before and after welding of external terminals according to the present disclosure;

FIG. 5 is a side cross-sectional view of an example of a battery enclosure according to the present disclosure;

FIG. 6 is a top perspective view of an example of a cover of the battery enclosure according to the present disclosure;

FIG. 7 is a bottom perspective view of an example of a cover of the battery enclosure according to the present disclosure;

FIG. 8 is a partial side cross-section view of an example of the cover according to the present disclosure;

FIG. 9A is a partial side cross-section view of another example of a battery enclosure according to the present disclosure;

FIG. 9B is a side cross-section view of an example of a positive terminal according to the present disclosure;

FIG. 9C is a side cross-section view of another example of a positive terminal according to the present disclosure;

FIG. 10 is a flowchart of an example of a method for manufacturing the battery system according to the present disclosure; and

FIG. 11 is a flowchart of another example of a method for manufacturing the battery system according to the present disclosure.

In the drawings, reference numbers may be reused to identify similar and/or identical elements.

### DETAILED DESCRIPTION

While the battery and battery enclosure according to the present disclosure are described below in the context of a vehicle, the battery and battery enclosure according to the present disclosure can be used in other applications.

Bipolar solid-state batteries according to the present disclosure include parallel-connected anode and cathode electrodes that are arranged as a battery cell core. Then, multiple battery cell cores are connected in series between clad plates. A battery enclosure includes channels to receive and position the clad plates. In some examples, terminals of the battery are molded into end walls of the battery enclosure.

The anode electrodes and cathode electrodes can be fabricated using traditional lithium-ion battery (LIB) fabrication to ensure cell consistency. The clad plates support series connection of the battery cells and higher output voltages. The clad plates provide fast electron transportation with short electron pathways. The battery enclosure is light weight and hermetically sealed to prevent moisture and oxygen flow and leakage of the electrolyte. The battery is tab free, which will increase reliability.

Bipolar solid-state batteries according to the present disclosure improve the energy density by reducing the number of connecting tabs, battery packages, and/or cooling systems that are needed for a desired amp hour (Ah) capacity. The voltage output of the bipolar solid-state battery can be increased by increasing the number of series-connected battery cells. However, it is very difficult to fabricate Ah-level cell/modules for 12V start/stop applications, in terms of electrochemical performance and fabrication processes.

Theoretically, an increased capacity (Ah) of the bipolar solid-state batteries can be realized by using a larger bipolar electrodes or connecting the bipolar cells in parallel. This strategy is facing barriers such as the control of battery cell consistency. Thus, a reliable battery design together with its fabrication process are desired.

In some examples, a tab-free bipolar solid-state battery according to the present disclosure includes multiple solid-state cells connected in series using the clad plates. The solid-state battery cells are integrated into the tab-free, light-weight battery enclosure.

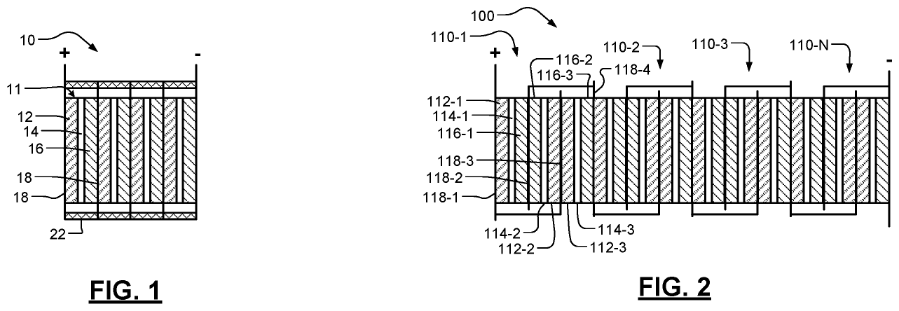

Referring now to FIG. 1, an example of a bipolar battery 10 is shown and includes a plurality of bipolar battery cells 11 that are connected in series. The bipolar battery cells 11 include a current collector 18, an anode electrode 12, a separator 14, a cathode electrode 16 and a current collector 18. Blockers 22 may be arranged between opposite ends of the current collectors 18. Additional bipolar battery cells 11 are connected in series and arranged between positive and negative terminals of the bipolar battery 10 (corresponding to outermost current collectors 18).

The bipolar battery 10 in FIG. 1 has several disadvantages. The bipolar battery 10 has limited cell capacity, typically less than 1 Ah. The bipolar battery 10 is complex to manufacture. Inconsistency in the manufacturing of the bipolar battery 10 may lead to overcharging and/or short circuits.

Referring now to FIG. 2, an example of a bipolar solid-state battery 100 including a bipolar battery cells 110-1, 110-2, 110-3, . . . , and 110-N is shown. In this example, each of the bipolar battery cells 110-1, 110-2, 110-3, . . . , and 110-N includes a current collector 118-1, a cathode electrode 112-1 between the current collector 118-1 and a separator 114-1. An anode electrode 116-1 is arranged adjacent to the separator 114-1. A current collector 118-2 is arranged adjacent to the anode electrode 116-1.

An anode electrode 116-2 is arranged adjacent to the current collector 118-2. A separator 114-2 is arranged adjacent to the anode electrode 116-2. A cathode electrode 112-2 is arranged adjacent to the separator 114-2. A current collector 118-3 is arranged adjacent to the cathode electrode 112-2. A cathode electrode 112-3 is arranged between the current collector 118-3 and a separator 114-3. An anode electrode 116-3 is arranged adjacent to the separator 114-3. A current collector 118-4 is arranged adjacent to the anode electrode 116-3.

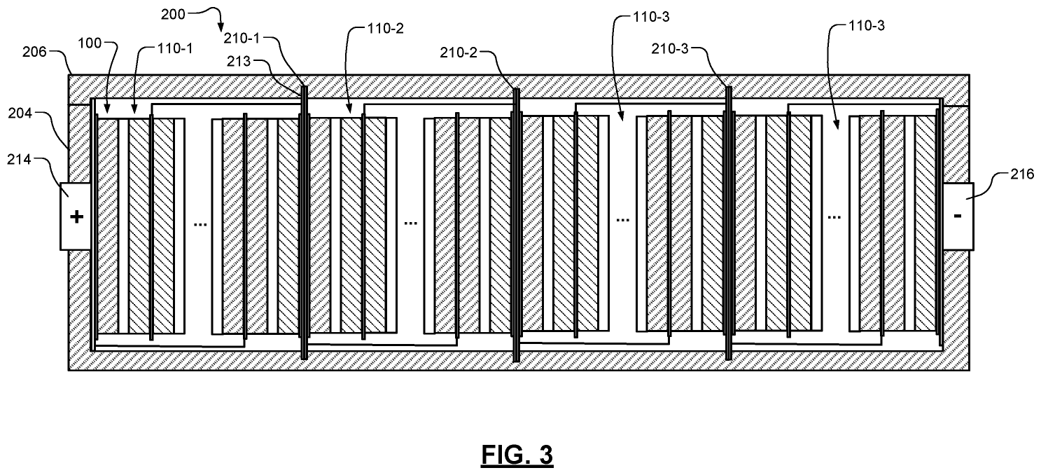

The current collectors 118-2 and 118-4 are connected together or shorted. The current collectors 118-1 and 118-3 are connected together or shorted. In some examples, external terminals of the current collectors are connected together as will be described further below. While each of the bipolar battery cells 110 are shown to include three pairs of anode electrodes and cathode electrodes, additional pairs can be used and connected in a similar manner (as generally shown in the example in FIG. 3).

The bipolar battery cells 110-2, 110-3, . . . , and 110-N have a similar arrangement. The bipolar battery cells 110-2, 110-3, . . . , and 110-N are connected in series between the positive and negative terminals. In some examples, N=4, although additional or fewer bipolar battery cells can be used.

Referring now to FIG. 3, the bipolar solid-state battery 100 is shown arranged in a battery enclosure 200. The battery enclosure 200 includes a lower portion 204 and a cover 206. In some examples, the lower portion of the battery enclosure 200 has a rectangular cross-section. The lower portion 204 includes a bottom surface, first and second side walls, and first and second end walls. Clad plates 210-1, 210-2, and 210-3 are arranged between the first and second sidewalls (adjacent bipolar battery cells). Outermost ones of the adjacent bipolar battery cells are arranged between a positive terminal 214 and one of the clad plates and a negative terminal 216 and one of the clad plates, respectively.

In some examples, the clad plates 210-1, 210-2, and 210-3 are received in channels 213 formed on one or more inner surfaces of the lower portion 204 and the cover 206 of the battery enclosure 200. In this example, the bipolar battery cell 110-1 is arranged between the positive terminal 214 and the clad plate 210-1. The bipolar battery cell 110-2 is arranged between the clad plate 210-1 and the clad plate 210-2. The bipolar battery cell 110-3 is arranged between the clad plate 210-2 and the clad plate 210-3. The bipolar battery cell 110-4 is arranged between the clad plate 210-3 and the negative terminal 216.

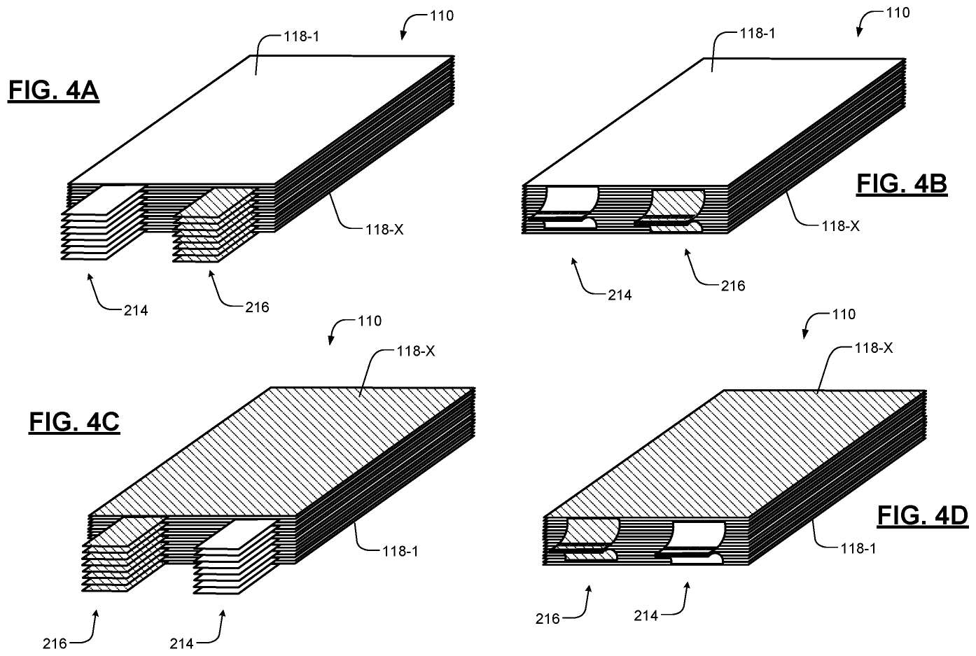

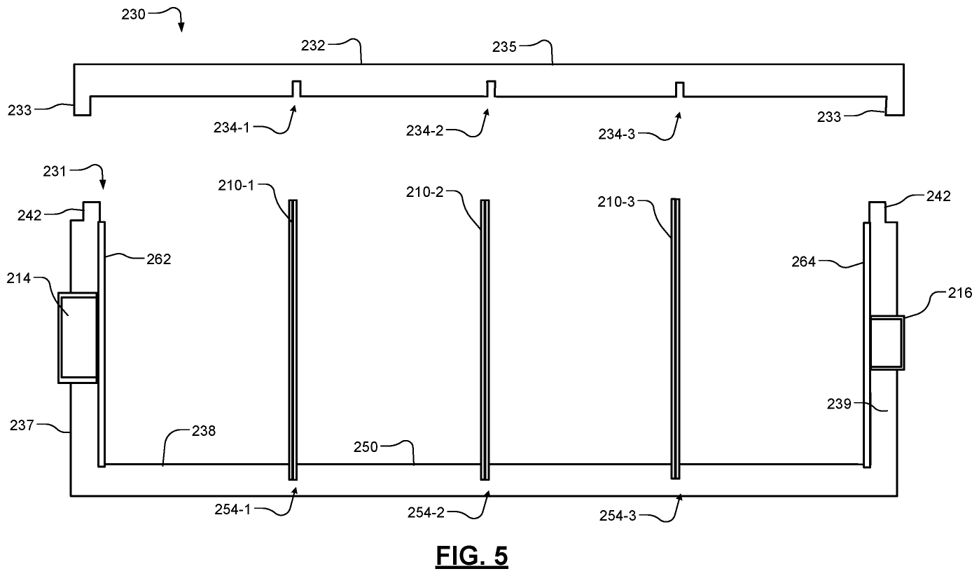

Referring now to FIGS. 4A to 4D, the bipolar battery cell 110 is shown before and after welding of external terminals. In FIGS. 4A and 4C, external terminals 214 are connected to cathode current collectors. External terminals 216 are connected to anode current collectors. In FIGS. 4B and 4D, the external terminals 214 are shorted. The external terminals 216 are shorted. In some examples, the external terminals are welded together. In some examples, an outermost cathode current collector 118-X are a single layer to enable fast current flow to the clad plates and/or terminals.

Referring now to FIG. 5, an example of a battery enclosure 230 including a lower portion 231 and a cover 232 is shown. In some examples, a body 235 of the cover 232 has a rectangular cross-section in a plan view and a “C”-shaped side cross-section. One or more first flanges 233 extend from the body 235 of the cover 232. In some examples, the one or more first flanges 233 are located along a bottom surface of the cover 232 around an edge thereof. The bottom surface of the cover 232 further includes channels 234-1, 234-2, and 234-3 configured to receive and position the clad plates 210-1, 210-2, and 210-3, respectively.

The lower portion 231 includes side walls and end walls 237 and 239 extending upwardly from a bottom surface 238. In some examples, the bottom surface 238 further includes channels 254-1, 254-2, and 254-3. In some examples, the channels 234-1, 234-2, and 234-3 and the channels 254-1, 254-2, and 254-3 are arranged relative to one another such that the clad plates 210-1, 210-2, and 210-3 are arranged parallel to each other, parallel to the first and second end walls (e.g., 237 and 239) and transverse to first and second side walls (not shown in FIG. 5; shown below).

An end plate 262 is arranged along the side wall 237 and in contact with the terminal 214 and one of the battery cells. An end plate 264 is arranged along the side wall 239 and in contact with the negative terminal 216 and one of the battery cells.

In some examples, the channels 234-1, 234-2, and 234-3 and the channels 254-1, 254-2, and 254-3 fix a position of the clad plates. In some examples, the width of the channels 234-1, 234-2, and 234-3 and the channels 254-1, 254-2, and 254-3 are greater than or equal to the thickness of the clad plates and have a depth in a range from 0.2 mm to 5 mm.

In some examples, the clad plates 210-1, 210-2, and 210-3 comprise an aluminum/copper (Al/Cu) clad plate having a thickness in a range from 0.2 mm to 5 mm. In some examples, the thickness of the clad plates 210-1, 210-2, and 210-3 is in a range from 0.8 mm to 1.2 mm (e.g., 1 mm).

Referring now to FIGS. 6 and 7, top and bottom surfaces of the cover 232 of the battery enclosure 200 are shown, respectively. The cover 232 includes vent holes 270-1, 270-2, 270-3, and 270-4 corresponding to each of the bipolar battery cells 110-1, 110-2, 110-3, and 110-4. In some examples, fasteners 272-1, 272-2, 272-3, and 272-4 are arranged in the vent holes 270-1, 270-2, 270-3, and 270-4 after filling the battery enclosure with polymer electrolyte or liquid electrolyte. Sealing polymer may be used to seal and fix the fasteners 272 in place.

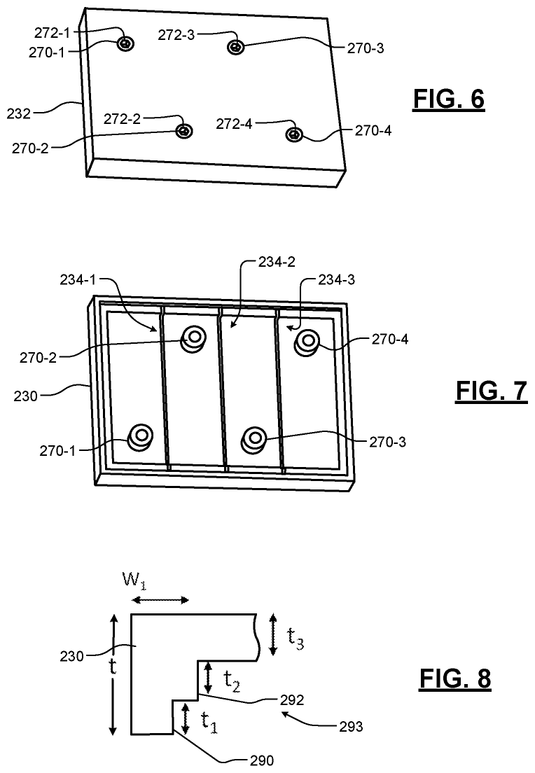

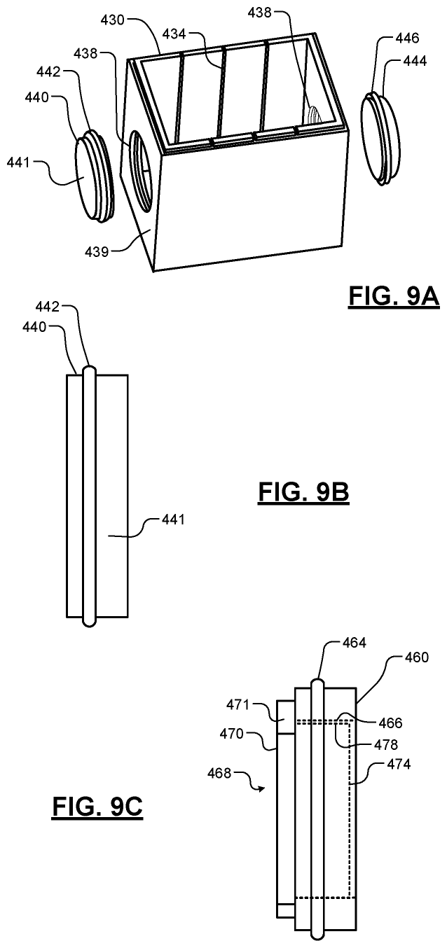

In FIGS. 7 and 8, the cover 232 includes a first stair-stepped surface including a first step 290 and a second step 292. Upper edges of the lower portion 204 include a second stair-stepped surface (shown in FIG. 9A) that mates with the first stair-stepped surface. In some examples, the thickness t3 of the body of the cover 232 inward of the first and second steps is in a range from 0.5 mm to 10 mm. In some examples, the thickness t2 of the first step 290 is in a range from 0.5 mm to 3 mm. In some examples, the thickness t1 of the second step 292 is in a range from 0.5 mm to 3 mm. In some examples, the combined width of the first step 290 and the second step 292 is in a range from 0.5 to 10 mm. In some example, t=t1+t2+t3.

In some examples, the vent holes 270-1, 270-2, 270-3, and 270-4 are configured to receive and distribute polymer or gel electrolyte during manufacture and allow gas to escape during polymerization. After polymerization, the vent holes 270-1, 270-2, 270-3, and 270-4 are sealed by a fastener and a sealing polymer.

In some examples, the edge of the cover and the lower portion of the battery enclosure are machined with tolerances that closely match. In some examples, the cover and the lower portion of the battery enclosure are made of a material selected from a group consisting of polyvinyl chloride (PVC), polyvinylidene fluoride (PVDF), polytetrafluoethylene (PTFE), chlorinated polyvinyl chloride (CPVC), chlorinated polyethylene (CPE), polypropylene (PP), polyethylene (PE), polybutylene (PB), and combinations thereof.

Referring now to FIGS. 9A and 9B, a partial side cross-section view of an example of a battery enclosure 430 and a terminal 440 are shown, respectively. An opening 438 is arranged in an end wall 439 and is configured to receive a terminal 440. In some examples, the battery enclosure 430 is injection molded around the terminal 440. In some examples, the terminal 440 comprises a flat cylinder 441 and a flange 442 extending radially outwardly therefrom. The flange 442 helps to retain the terminal 440 in the opening 438 after molding. A terminal 444 is likewise arranged in the opening 438 on an opposite end wall. In some examples, the terminal 444 includes a flat cylinder and a flange 446 extending radially outwardly therefrom.

In some examples, the positive terminal (e.g., terminal 440 or 444) is made of a material selected from a group consisting of stainless steel, aluminum, nickel, iron, titanium, tin, and alloys thereof. In some examples, the negative terminal (e.g., terminal 444 or 440) is made of a material selected from a group consisting of stainless steel, copper, nickel, iron, titanium, tin, and alloys thereof.

Referring now to FIG. 9C, a terminal 468 includes an annular body 460 defining an inner cavity 466. In some examples, the inner cavity 466 is threaded. The annular body 460 includes a flange 464 extending radially outwardly therefrom. In some examples, a thickness of the terminal 468 is approximately equal to a wall thickness of the first and second end walls of the battery enclosure 430. As used herein, approximately means within a range of +/−5%.

A terminal cap 470 includes a cylindrical body 474 and a flange 471 extending radially outwardly from the cylindrical body 474 at one side thereof. In some examples, an outer surface of the cylindrical body 474 is threaded. The flange 471 is biased against the annular body 460 to provide a stop when the terminal cap 470 is fully threaded onto the annular body 460. In some examples, the flange 470 has a male hexagonal outer edge to allow engagement with a female hexagonal-shaped tool.

In some examples, the battery enclosure 430 (FIG. 9A) is injection molded around the annular body 460. The terminal cap 470 is threaded onto the annular body 460 either before injection molding or after injection molding. As can be appreciated, the terminal cap 470 may be screwed in after assembly and the electrolyte is added and/or polymerized to pressurize the battery enclosure 430 after assembly.

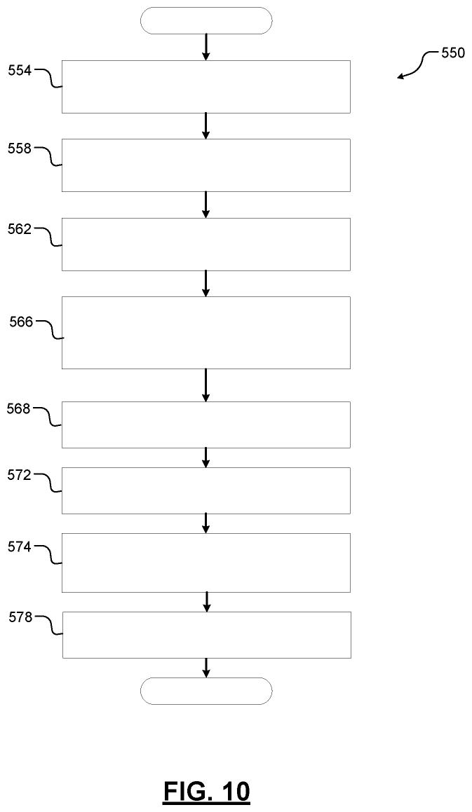

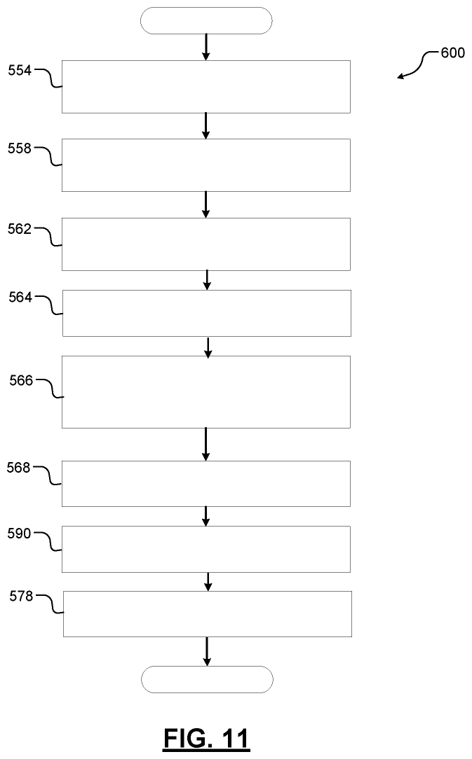

Referring now to FIG. 10, a method 550 for manufacturing the battery system is shown. At 554, the anode electrodes, the separators, and the cathode electrodes are fabricated.

In some examples, the cathode and anode electrodes may be fabricated using a wet coating process. For example, a dispenser dispenses cathode active material onto opposite sides of a cathode current collector (e.g., aluminum foil). Drying and calendaring is performed and then the cathode electrodes are punched one or more times to separate the cathode electrodes and/or to define external cathode terminals. For example, a dispenser dispenses anode active material onto opposite sides of an anode current collector (e.g., copper foil). Drying and calendaring is performed and then the anode electrodes are punched one or more times to separate the anode electrodes and/or to define external anode terminals.

At 558, the anode electrodes, the separators, and the cathode electrodes are stacked into battery cells. At 562, external terminals of current collectors of the anode electrodes are welded together and external terminals of current collectors of the cathode electrodes are welded together to provide parallel connections within the battery cells. At 564, the clad plates are arranged in the channels in the lower portion of the battery enclosure.

At 566, the battery cells are inserted in the lower portion of the battery enclosure between the positive terminal and the adjacent clad plate, between the negative terminal and the adjacent clad plate and/or between adjacent clad plates of the battery enclosure.

At 568, the cover is arranged over the lower portion of the battery enclosure and the channels are aligned with the clad plates.

At 572, polymer electrolyte precursor is injected through the vent holes in the cover and into the battery enclosure. At 574, the battery enclosure and battery cells are heated to a predetermined temperature for a predetermined period to perform in situ polymerization. For example, the battery enclosure and battery cells are heated to 80° C. for a period of 2 hours. At 578, fasteners are inserted into the vent holes. In some examples a sealing polymer may be used to provide a seal around the fasteners. In some examples, heating may be performed to create a gel.

Referring now to FIG. 11, a method 600 for manufacturing the battery system is shown. Steps 554 to 568 are performed as described above. At 590, liquid electrolyte is injected though the vent holes. At 578, fasteners are inserted into the vent holes. In some examples a sealing polymer may be used to provide a seal around the fasteners.

In some examples, the cathode active material is selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In some examples, the positive electroactive material is coated (for example, by LiNbO₃ and/or Al₂O₃) and/or the positive electroactive material is doped (for example, by aluminum and/or magnesium).

In some examples, the anode active material is selected from a group consisting of a carbonaceous material, silicon, a transition metal, a metal oxide, a lithium metal, a lithium alloy metal (e.g., tin, aluminum, indium, magnesium) and combinations thereof.

In some examples, the sealing polymer has a thickness in a range from 2 μm to 200 μm. In some examples, the sealing polymer is selected from a group consisting of hot-melt adhesive (e.g., urethane resin, polyamide resin, polyolefin resin), polyethylene resin, polypropylene resin, a resin containing an amorphous polypropylene resin as a main component and obtained by copolymerizing ethylene, propylene, and/or butene, silicone, polyimide resin, epoxy resin, acrylic resin, rubber (ethylene propylenediene rubber (EPDM)), isocyanate adhesive, acrylic resin adhesive, cyanoacrylate adhesive, or combinations thereof.

In some examples, the polymer electrolyte precursor includes a polymer and an initiator. In some examples, the polymer is selected from a group consisting of ethylene oxide (EO), vinylidene fluoride (VDF), vinylidene fluoride-hexafluoropropylene (VDF-HFP), propylene oxide (PO), acrylonitrile (AN), methacrylonitrile (PMAN), methyl methacrylate (MMA), and their corresponding oligomers and co-polymers.

In some examples, the initiators are selected from a group consisting of peroxide, azo compounds, and peroxide and a reducing agent. Examples of peroxide include Di(4-tert-butylcyclohexyl, peroxydicarbonate, and benzoyl peroxide (BPO). An examples of an azo compound includes azodicyandiamide (AIBN). Examples of the reducing agent include a low-valence metal salt such as, S₂O₄²⁻+Fe²⁺, Cr³⁺, Cu⁺.

In some examples, the polymer precursor solution comprises of 0˜5 wt % initiators, 0˜20 wt % polymers, and 80˜99 wt % liquid electrolyte. In other examples, the polymer precursor solution comprises of less than 0.5 wt % initiators, less than 5 wt % polymer, and >90 wt % liquid electrolyte.

In other examples, the liquid electrolyte is selected from a group consisting of traditional electrolyte and ionic liquids. In some examples, the traditional electrolyte comprises carbonate solvents and lithium salts. In some examples, the carbonate solvents are selected from a group consisting of ethylene carbonate (EC), dimethyl carbonate (DMC), ethyl methyl carbonate (EMC), diethyl carbonate (DEC), and propylene carbonate (PC), etc. In some examples, the lithium salts have a concentration >0.8 moles/liter (mol/L).

In some examples, the lithium salts include at least one lithium salt selected from a group consisting of bis(trifluoromethanesulfonyl)imide(LiTFSI), lithium bis(fluorosulfonyl)imide (LIFSI), lithium bis (perfluoroethyl-sulfonyl)imide (LiBETI), lithium hexafluorophosphate (LiPF₆), lithium bis (oxalato)borate (LiBOB), lithium difluoro (oxalato)borate (LiDFOB), lithium tetrafluoroborate (LiBF₄), lithium hexafluoroarsenate (LiAsF₆), lithium perchlorate (LiClO₄), and lithium trifluoromethane sulfonate (LiTfO). In some examples, the traditional electrolyte may further comprise an additive selected from a group consisting of vinylene carbonate (VC), butylene carbonate (BC), fluoroethylene carbonate (FEC), and combinations thereof.

In some examples, the ionic liquids comprise solvated ionic liquids and lithium salts. Examples of solvated ionic liquids include tetraethylene glycol dimethyl ether (G4) and triethylene glycol dimethyl ether (G3). Examples of lithium salts include LiTFSI, LIFSI, LiBETI, LiPF₆, LiBOB, LiDFOB, LiBF₄, LiAsF₆, LiClO₄, and LiTfO.

In other examples, the aprotic ionic liquids include cations, anions and lithium ions. In some examples, the cations are selected from a group consisting of N-methyl-N-propylpiperidinium (PP13+); N-methyl-N-butylpiperidinium (PP14+); N-methyl-N-propylpyrrolidinium (Py13+); 1-ethyl-3-methylimidazolium (EMI+), and combinations thereof. In some examples, the anions are selected from a group consisting of bis(fluorosulfonyl)imide (FSI−); bis(trifluoromethanesulfonyl)imide (TFSI−); bis(pentafluoroethanesulfonyl)imide (BETI−); hexafluorophosphate (PF₆−); tetrafluoroborate (BF4−); trifluoromethyl sulfonate (TfO−); difluoroborate (DFOB−) and combinations thereof. The ionic liquids may further comprise a diluent additive selected from a group consisting of 1,1,2,2-tetrafluoroethyl-2,2,3,3-tetrafluoropropyl ether (HFE); fluoroethylene carbonate (FEC); TTE, and combinations thereof.

In some examples, the separator comprises a polypropylene (PP) or polyethylene (PE) layer that is coated with lithium aluminum titanium phosphate (LATP).

In some examples, the electrolyte comprises an oxide-based solid electrolyte selected from a group consisting of doped or undoped garnet electrolyte, perovskite electrolyte, NASICON electrolyte, LISICON electrolyte, and metal-doped or aliovalent-substituted oxide solid electrolyte. Examples of garnet type include Li₇La₃Zr₂O₁₂. Examples of perovskite type include Li₃ₓLa_{2/3-x}TiO₃. Examples of NASICON type include Li_{1.4}Al_{0.4}Ti_{1.6}(PO₄)₃ and Li1+x AlxGe₂₋ₓ(PO₄)₃. Examples of LISICON type include Li₂₊₂ₓZn₁₋ₓGeO₄). Examples of metal-doped or aliovalent-substituted oxide solid electrolyte include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂.

In some examples, a mixture of the liquid electrolyte, precursor solutions and initiator form gel electrolyte insitu in response to heating at 80° C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A bipolar solid-state battery comprising:
N solid-state battery cells, where N is an integer greater than one,
wherein each of the N solid-state battery cells comprises:
M solid-state cores each comprising a first current collector, cathode active material, a separator, anode active material, and a second current collector, where M is an integer greater than one,
wherein the M solid-state cores are connected in parallel by connecting the first current collectors of the M solid-state cores in each of the N solid-state battery cells together and by connecting the second current collectors of the M solid-state cores in each of the N solid-state battery cells together, and
N−1 clad plates including a first side made of a first material and a second side made of a second material,
wherein the N−1 clad plates are arranged between adjacent ones of the N solid-state battery cells and the N solid-state battery cells are connected in series by the N−1 clad plates.

2. The bipolar solid-state battery of claim 1, wherein the first current collector comprises aluminum and the second current collector comprises copper.

3. The bipolar solid-state battery of claim 1, wherein the first material of the N−1 clad plates comprises copper and the second material of the N−1 clad plates comprises aluminum.

4. The bipolar solid-state battery of claim 1, further comprising:
a battery enclosure, wherein the N solid-state battery cells and the N−1 clad plates are arranged in the battery enclosure.

5. The bipolar solid-state battery of claim 4, further comprising:
a first terminal in contact with the first current collector of a first one of the N solid-state battery cells and passing through one side of the battery enclosure; and
a second terminal in contact with the second current collector of a last one of the N solid-state battery cells and passing through an opposite side of the battery enclosure.

6. The bipolar solid-state battery of claim 4, further comprising an electrolyte.

7. The bipolar solid-state battery of claim 6, wherein the electrolyte comprises polymer electrolyte and an initiator.

8. The bipolar solid-state battery of claim 7, further comprising a battery enclosure for the N solid-state battery cells, wherein the polymer electrolyte is polymerized insitu in the battery enclosure.

9. The bipolar solid-state battery of claim 7, wherein the polymer electrolyte is selected from a group consisting of ethylene oxide (EO), vinylidene fluoride (VDF), vinylidene fluoride-hexafluoropropylene (VDF-HFP), propylene oxide (PO), acrylonitrile (AN), methacrylonitrile (PMAN), methyl methacrylate (MMA), and their corresponding oligomers and co-polymers.

10. The bipolar solid-state battery of claim 7, wherein the initiator is selected from a group consisting of peroxide, azo compounds, and peroxide and a reducing agent.

11. The bipolar solid-state battery of claim 4, wherein the battery enclosure includes a base portion and a cover.

12. The bipolar solid-state battery of claim 11, wherein the cover includes N vent holes arranged between the N−1 clad plates, between a first one of the N−1 clad plates and one side of the battery enclosure, and between a last one of the N−1 clad plates and an opposite side of the battery enclosure.

13. The bipolar solid-state battery of claim 12, further comprising N fasteners arranged in the N vent holes.

14. The bipolar solid-state battery of claim 13, further comprising sealing polymer sealing the N fasteners in the N vent holes.

15. The bipolar solid-state battery of claim 6, wherein the electrolyte comprises liquid electrolyte.

16. The bipolar solid-state battery of claim 15, wherein the liquid electrolyte is selected from a group consisting of a solvated ionic liquid and an aprotic ionic liquid.

17. The bipolar solid-state battery of claim 1, wherein the cathode active material includes one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

18. The bipolar solid-state battery of claim 1, wherein the anode active material is selected from a group consisting of a carbonaceous material, silicon, a transition metal, a metal oxide, a lithium metal, a lithium alloy metal, and combinations thereof.

19. The bipolar solid-state battery of claim 1, wherein the separator comprises a polymer layer that is coated with lithium aluminum titanium phosphate (LATP) and wherein the polymer layer is selected from a group consisting of polypropylene (PP) and polyethylene (PE).

20. The bipolar solid-state battery of claim 6, wherein the electrolyte comprises an oxide-based solid electrolyte selected from a group consisting of doped or undoped garnet electrolyte, perovskite electrolyte, NASICON electrolyte, LISICON electrolyte, metal-doped oxide solid electrolyte, and aliovalent-substituted oxide solid electrolyte.
